(19) United States
(12) Patent Application Publication
(10) Pub. No.: US 2003/0070535 A1
(43) Pub. Date: Apr. 17, 2003

(54) MusiCoveralls

(76) Inventor: Patricia Anne Tuite, Storrs, CT (US)

Correspondence Address: Patricia Anne Tuite, 205 Separatist Road, Storrs, CT, 06268, US

(21) Appl. No.: 10/219,112

(22) Filed: Aug. 15, 2002

Related U.S. Application Data
(60) Provisional application No. 60/314,551, filed on Aug. 24, 2001.

(51) Int. Cl. G10G 1/00

(52) U.S. Cl. 84/453

(57) ABSTRACT

A protective pad for use covering the vulnerable components of music sound equipment such as guitar or bass amplifiers, speakers, and public address systems. When the pad is attached, it is form-fitting to the front, covering the knobs, screens, or fabric which might otherwise be damaged when left exposed. The way in which the pad attaches to the music equipment allows it to remain attached even while the equipment is in use, which saves space and can provide a cushioned surface for further protection and use.

### CROSS-REFERENCE TO RELATED APPLICATIONS—Not Applicable

### STATEMENT REGARDING FEDERALLY SPONSORED RESEARCH OR DEVELOPMENT—Not Applicable

### REFERENCE TO A MICROFICHE APPENDIX—Not Applicable

### BACKGROUND OF THE INVENTION

I am a musician. As a musician, it is necessary to transport musical equipment to and from engagements. For years, the equipment has been nicked, dented, damaged, and pieces broken due to a lack of protective padding. Fabric has been snagged and torn, creating cosmetic damage, as well. I have tried blankets, tarps, and even plastic trash liners to protect equipment, but the use of these can be unwieldy at times and looks unprofessional. When I have requested a cover from manufacturers, many times they do not have one or the one that may exist is bulky and has no padding. In addition, musicians often have limited space in which to place their belongings while performing, which makes an amplifier “case” get in the way. Out of necessity, I created a unique form of protection for my equipment which is not bulky, is padded, and can be left attached to the top or bottom of the equipment while it is in use, making it useful as a protective cushion even when the equipment is in use.

### BRIEF DESCRIPTION OF THE INVENTION

MusiCoveralls is the name of a protective pad for use covering the vulnerable surfaces and components of music sound equipment, such as guitar or bass amplifiers, speakers, and public address systems. When the pad is attached, it is form-fitting to the front, covering the knobs, screens, or fabric which might otherwise be damaged when left exposed. The size and material of the outside of the pad can be manufactured to adapt to the size of the musical equipment and the aesthetic desires of the consumer. Pockets can be added as well, for cords or other small items to store. MusiCoveralls saves space, provides protection from the damage that can occur while shifting and/or bumping into other equipment during transport, and does not need to be removed from the equipment when it is in use, which is a unique application of this invention.

### BRIEF DESCRIPTION OF THE DRAWINGS

FIG. 1. A view from the back, showing the attachment of hook and loop strips to the top and bottom. The front view is identical with the exception that no strips are attached.

FIG. 2. A view from the side, showing the effect of the soft foam in the interior.

FIG. 3. A view of approximately 35 degrees, which shows a slight view of the front, and most of the back view.

FIG. 4. Shows the beginning of the application of the pad to the musical equipment, with the hook and loop attachment partially applied to the top.

FIG. 5. Shows the top of the MusiCoveralls attached, ready to attach the rest of it.

FIG. 6. Shows the pad fully applied to the musical equipment.

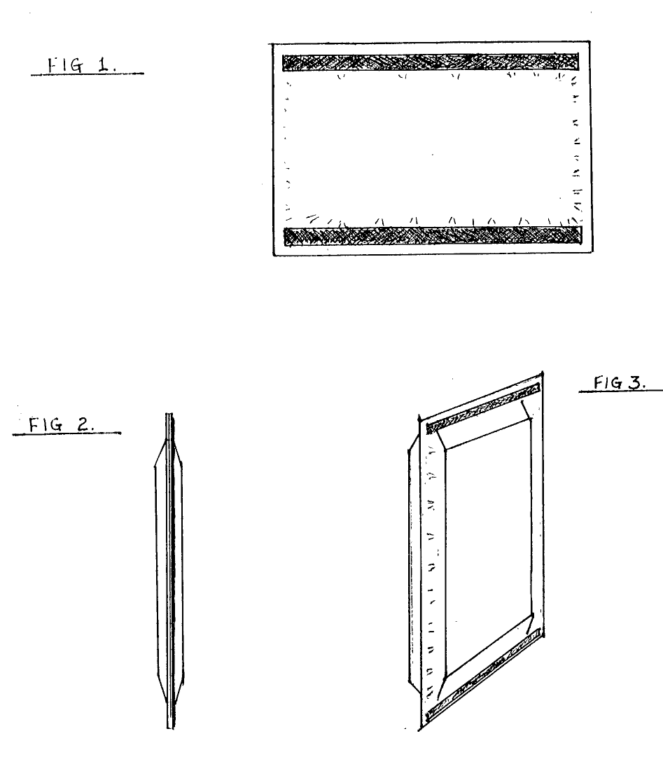

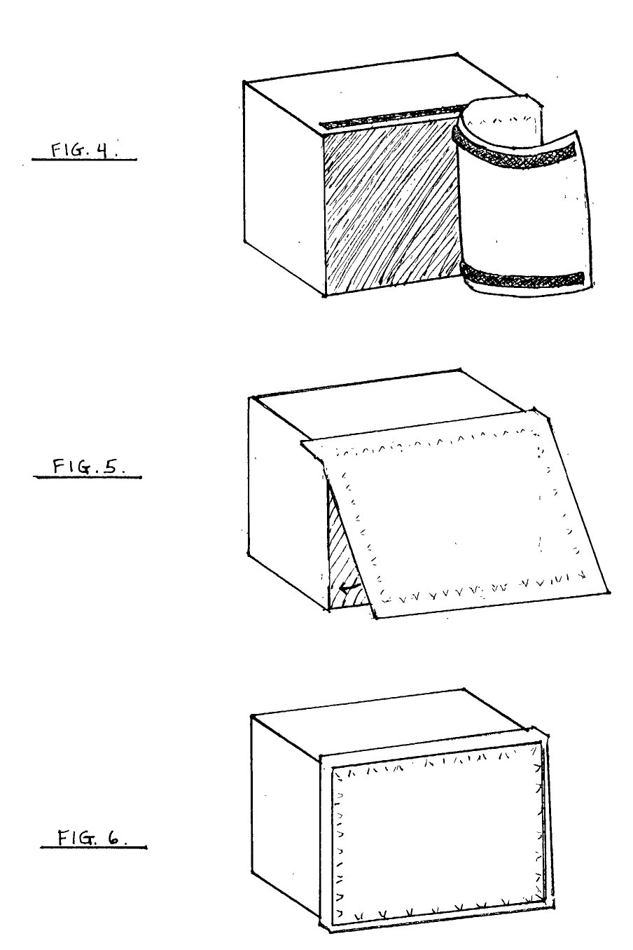

### DETAILED DESCRIPTION OF THE INVENTION

The protective pad is constructed by taking two pieces of durable, water-repellent material and sewing a piece of resilient, flexible urethane foam (approximately 1′ to 2′ thick) between the two pieces of material. The edges are sewn together and vinyl stripping may be added for durability. The top and bottom of the pad have an additional 3′ of fabric in order to attach the hook and loop strips, which correspond to hook and loop strips which are adhered to the top and bottom of the music equipment. When the hook and loop strips are aligned and attached together, it is form-fitting to the front, covering the knobs, screens, or fabric which might otherwise be damaged when left exposed. The size and material of the outside of the pad can be manufactured to adapt to the size of the musical equipment and the aesthetic desires of the consumer. Pockets can be sewn onto the pad as well, for cords or other small items to store. MusiCoveralls may be removed and reattached from the music equipment at any time.

### I claim the following:

1. A music equipment protective cover, comprised of a piece of resilient foam sewn between two pieces of fabric, utilizing hook and loop strips to attach said cover to the music equipment, sized to fit the section(s) of the music equipment which are susceptible to damage, such as control knobs and speaker grids.

2. The music equipment protective cover according to claim 1, wherein pockets may be added to store small items.

3. The music equipment protective cover according to claim 1, wherein the hook and loop strips allow the cover to be flipped to the top or bottom while remaining attached, saving space and providing a cushioned surface to further protect the equipment while it is in use.

4. The music equipment protective cover according to claim 1, wherein the hook and loop strips allow the cover to be removed completely if desired.

5. The music equipment protective cover according to claim 1, wherein the material used to cover the foam has water-repellent properties.
